(19) United States
(12) Patent Application Publication
(10) Pub. No.: US 2010/0234209 A1
(43) Pub. Date: Sep. 16, 2010

(54) PARTICLE COMPRISING CORE AND SHELL AND APPLICATIONS THEREOF

(75) Inventors: Yukiko Furukawa, Enschede (NL); Olaf Wunnicke, Eindhoven (NL); Robertus A. M. Wolters, Eindhoven (NL); Nynke Verhaegh, Arnhem (NL)

Correspondence Address: NXP, B.V.;NXP INTELLECTUAL PROPERTY & LICENSING, M/S41-SJ, 1109 MCKAY DRIVE, SAN JOSE, CA, 95131, US

(73) Assignee: NXP B.V., Eindhoven (NL)

(21) Appl. No.: 12/738,129

(22) PCT Filed: Oct. 13, 2008
(86) PCT No.: PCT/IB08/54206

§ 371 Date: Apr. 15, 2010

(30) Foreign Application Priority Data
Oct. 16, 2007 (EP) 07118541.7

(51) Int. Cl. B01J 35/02; C09C 1/00; C09C 1/36; C09C 1/28; C09C 1/44; C09K 3/32; H01B 1/00

(52) U.S. Cl. 502/100; 428/403; 428/323; 428/404; 252/500; 977/773

(57) ABSTRACT

The present invention relates to particles comprising a core and a shell, a method of producing said particle, various uses of said particle as well as various products comprising said particle. The particle according to the invention may be used as photocatalyst, as antibacterial agent, as cleaning agent, as anti-fogging agent and as decomposing agent. Furthermore the particle is applicable as solar cells.

### FIELD OF THE INVENTION

The present invention relates to particles comprising a core and a shell, a method of producing said particles, various uses of said particle as well as various products comprising said particle.

### BACKGROUND OF THE INVENTION

Particles comprising a core and a shell are known.

US2007/187463 A1 discloses nanosized semiconductor particles of a core/shell structure, wherein the particles each comprise a core and a shell and exhibit an average particle size of not more than 100 nm and a coefficient of variation in core size distribution of not more than 30%.

However, these particles are typically much smaller than 100 nm, do not comprise a conducting core and/or a dielectric or semiconducting shell.

WO2007/086267 A1 discloses semiconductor nanoparticles having a core/shell structure in which the ratio of the shell thickness to the particle diameter of the core part is a value optimal for an optical property required of an optical element. The semiconductor nanoparticles have a core/shell structure in which the thickness of the shell part is not larger than one-half the particle diameter of the core part. The particle diameter of the core part is less than 20 nm and the thickness of the shell part is 0.2 nm or larger. Alternatively, the particle diameter of the core part is 20-100 nm and the thickness of the shell part is at last 1/100 the particle diameter of the core part. The core part contains at least one element selected from the group consisting of B, C, N, Al, Si, P, S, Zn, Ga, Ge, As, Se, Cd, In, Sb, and Te. The semiconductor nanoparticles are characterized in that the shell part comprises a composition having a larger band gap than the core part.

However, these particles are typically much smaller than 100 nm, do not comprise a conducting core and/or a dielectric or semiconducting shell.

W02005/100426 A1 discloses a nanoparticle of core-shell type and a method of preparing the same, a method of preparing a low dielectric insulation film using the same, and a low dielectric insulation film prepared therefrom. More specifically, the invention discloses nanoparticles, which include an organic polymer core particle with a network structure and a shell-layer of a silsesquioxane pre-polymer surrounding the core particle. In addition, a method of preparing these nanoparticles is described.

JP2006224036 discloses a novel photocatalyst and a method of a photocatalytic reaction, which can efficiently perform a photocatalytic reaction such as nitrogen containing organic compound. The photocatalyst is provided with a core consisting of a semiconductor nanoparticle and a shell covering the core through a void, and comprises a core/shell structural body having the void controlled inside of the shell. The photocatalytic reaction (excluding a dehydrating reaction of methanol as a substrate) is performed by an electron and/or a positive hole generated by the photoirradiation of the semiconductor nanoparticle. The core comprising at least two different nanoparticle composite bodies may be used which are bonded with the semiconductor nanoparticle and the catalyst nanoparticle.

The present invention does not disclose a particle with a void. Further, these particles are typically very small, do not comprise a conducting core and/or a dielectric or semiconducting shell, and comprise a core with at least two different bodies.

CN1792445 discloses a nano-class semiconductor-type composite catalyst of a semiconductor nanoparticle consisting of the sulfide or selenide as core and the coated TiO₂ layer as shell. Its preparing process includes such steps as preparing high-dispersity cadmium sulfide (or selenide) nanoparticles by a wet chemical method and surfactant modifying, ultrasonic hydrolysis of the organic alkoxide of Ti to obtain TiO₂, and physical combination between TiO₂ and cadmium sulfide (or selenide) nanoparticles. It has a high photocatalytic activity and stability.

This document is silent on particle sizes, does not disclose a conducting core and/or a dielectric or semiconducting shell.

U.S. Pat. No. 6,908,881 B1 discloses a catalyst having activity under the irradiation of a visible light, the catalyst being an oxide semiconductor such as an anatase type titanium dioxide, having stable oxygen defects. A method for producing a catalyst having activity under the irradiation of visible light which comprises treating an oxide semiconductor with hydrogen plasma or with a plasma of a rare gas element, comprising performing the treatment in a state substantially free from the intrusion of air into the treatment system is also provided. An article comprising a base material having the catalyst above provided on the surface thereof and a method for decomposing a substance, comprising bringing an object to be decomposed into contact with the catalyst above under the irradiation of a light containing at least a visible radiation are disclosed. A novel photocatalyst, which enables use of a visible radiation, is provided, as well as a method utilizing the photocatalyst for removing various substances containing an organic matter or bacteria by photodecomposition.

This invention is however not directed to particles, but to oxide semiconductor layers.

US2004/258762 A1 discloses a microparticle that contains a cross-linked protein shell, and a covalently attached surface coating.

The application is however silent on the electrical characteristics of the particles disclosed therein. The microparticles are used as optical contrast agents. Further, the present invention is not related to an optionally cross-linked protein comprising shell.

US2004/245496 A1 discloses a novel cleaning agent comprising at least one member of the group consisting of TiOₓ(1.5<x<2), TiOₓN₂₋ₓ(1<x<2), diamond-like carbon, and a titania-silica complex TiOₓ—SiO₂(1.5<x<=2), and a method for cleaning objects with said cleaning agent. The invention further provides an antibacterial material containing the above-mentioned materials, an antibacterial product featuring the same, a method for manufacturing an environmental material, a novel functional adsorbent, and a method for manufacturing the same.

The particle sizes are, however, typically much smaller than 100 nm. Furthermore, the relative amount of TiOₓ is much higher than in the present invention.

JP2003/064278 discloses core-shell semiconductor nanoparticles having both reduction of photocatalytic capability and dispersibility into an organic matrix and it provides a resin composition using the same. The core-shell semiconductor nanoparticles include core-shell particles having a number average particle size of 2-50 nm comprised of semiconductor nanocrystal cores and conductor shells with surface-modifying molecules bonded to the surface thereof.

The particle sizes are, however, typically much smaller than 100 nm. Further, it is not very specific on characteristics of the particles.

DE 101 64 768 A1 discloses core-shell particles (I) with a core of inorganic nanoparticles with a particle size less than 100 nm and an inorganic oxide shell and which are largely, preferably completely, unagglomerated. Independent claims are also included for the following: (1) core-shell particles (II) produced from a core of inorganic nanoparticles with a particle size of under 100 nm and a shell of inorganic oxide/hydroxide, in which the shell is applied by a wet chemical reaction by changing the pH, using an enzymes, and the resultant powder is calcined after removing the solvent; similar core-shell particles (III), with a core of inorganic semiconductor nanoparticles with a particle size less than 100 nm and metal shell; (2) core-shell particles of type (III) in which the shell is produced by photo-induced redox reaction of metal ions on the semiconductor surface and the powder is calcined after removing the solvent.

The shell is, however conducting, the core is semi-conducting and the particle sizes are much smaller than with the present invention.

Various of these particles have a photoactivity, and can therefore be used as photocatalyst. The photoactivity is typically due to the presence of TiO₂, which is a well-known photocatalyst. However, TiO₂ can only be used as a photocatalyst when UV-radiation is present. It is therefore limited in use.

Embodiments have been proposed to improve the activity of TiO₂, amongst others by changing the structure of TiO₂. However, these improvements do not relate to particles.

As mentioned, titanium dioxide (TiO₂) is known as a photocatalyst under ultraviolet (UV) light, especially the anatase phase thereof exhibits a higher photocatalytic activity than the rutile phase. Recently a mixture of anatase and rutile was reported to have higher activities than those of pure anatase.

Further, TiO₂ is a very strong oxidant and can decompose water, i.e. break water into oxygen (O₂) and hydrogen (H₂). This is due to a strong oxidative potential of the positive holes in the catalyst. We note that the hydrogen gas could be used as fuel, thus TiO₂ has a potential for use in generating a source of energy.

TiO₂ can also oxidize organic materials directly. As TiO₂ is exposed to UV light, it becomes increasingly hydrophilic, thus it can be used for anti-fogging coatings or self-cleaning windows, whereby amongst others the organic materials are effectively removed. Furthermore, TiO₂ incorporated into outdoor building materials can substantially reduce concentrations of airborne pollutants such as volatile organic compounds and nitrogen oxides.

TiO₂ is thus added to paints, cements, windows, tiles, or other products for sterilizing, deodorizing and anti-fouling properties and is also used as a hydrolysis catalyst. It is also used in the Graetzel cell, a type of electrochemical solar cell.

It is noted that the anatase phase is not the most stable phase for TiO₂. The rutile phase is the most common natural form in TiO₂. It is therefore a problem to prepare the in many aspects more desired anatase phase, and further to maintain the anatase phase over a longer period of time.

Both water and air are essential for life on earth, but over 1.1 billion people in developing countries do not have safe drinking water, according to the UN. Further, 2 billion people do not have an adequate sanitation facility. Also 4.6 million people die each year from causes directly attributable to air pollution, according to WHO. Therefore, clean water and air, as well as proper sanitation, are of the utmost importance for the quality of life on earth. Present solutions to this problem have often been too costly, inefficient in terms of activity, unavailable, and too complicated. Thus a need for further solving these problems, or limiting the consequences thereof, still exists.

Counterfeiting of goods may lead to a huge loss in revenues, and may harm human health, due to for instance fake drugs. It increases significantly each year. Therefore anti-counterfeiting technology is becoming very important in more and more products. Recently a “coating with physical unclonable functions (Cpuf)” has been developed, which is a coating composite on an IC that is unique and can not be copied. Several patents were filed on a material composition of the coating, for instance, TiN, TiO₂, monoaluminium phosphate (MAP) and some dielectric materials in, for instance, U.S. Pat. No. 6,198,155 B1, U.S. Pat. No. 6,759,736 B2 and WO 03/046986A2. The dielectric or conductive particles are randomly distributed over the IC. In the upper part of IC a network of sensors may be present, which is made of Al electrodes. The randomness of the particle distribution contributes to a variety of capacitances over IC. This gives a kind of fingerprint, which, as mentioned, is difficult to copy.

However, hacking technology is improving every year, therefore an increasing level of characterizing bits and improved security is needed.

A problem with some of the above mentioned particles is further that, when required, the chemical/physical activity of the particles is too low or even absent. A further problem is that the activity is even limited to e.g. irradiation by UV-light. Furthermore, most of the materials mentioned above do not possess the electrical and/or dielectric and/or semiconducting and/or structural properties required for the applications mentioned below.

It is at present, however, very difficult or impossible to manufacture particles, which particles have a core and a shell of different material; and/or particles which are small, but for some applications not too small, i.e. wherein the core size is preferably larger than 100 nm and preferably smaller than 100 μm; and/or which particles are stable, e.g. do not alter over time spontaneously, do not undergo a phase transition, are stable in the environment of use, etc.

Further, it is very difficult, or impossible, to manufacture particles which are more or less uniform with respect to core size and shell thickness, specifically wherein the shell thickness is relatively small. Whenever shell thicknesses become relatively small, the shell typically tends to have open spacings within the shell. Also, such a shell typically contains areas that, upon chemical treatment, undergo no change, i.e. remain as before the treatment, as well as areas which are preferably treated, i.e. have a much larger thickness than the average thickness of the shell.

It is therefore the aim of the present invention to solve one or more of the above-mentioned problems.

### SUMMARY OF THE INVENTION

In a first aspect the invention discloses a particle, comprising a core and a shell, wherein the core comprises a first electrically conducting or semiconducting material, wherein the shell comprises a second dielectric or semiconducting material, wherein the composition of said second material is different from the composition of said first material, which shell has a thickness of more than 10 nm, preferably more than 30 nm, more preferably more than 50 nm, and wherein the shell has a thickness of less than 200 nm, wherein the core size is preferably larger than 100 nm, more preferably larger than 150 nm, even more preferably larger than 250 nm, even more preferably larger than 500 nm, most preferably larger than 1000 nm, and wherein the core size is preferably smaller than 100 μm, more preferably smaller than 50 μm, even more preferably smaller than 25 μm, even more preferably smaller than 10 μm, most preferably smaller than 3 μm.

Surprisingly, the present invention provides solutions to the above-mentioned problems. Furthermore, where applicable, it improves the performance of core-shell particles in one or more aspects. It also makes applications possible, which have not been possible up to now, or at the most in a limited form.

In a preferred embodiment the variation in relative thickness of the shell is less than ±20%, preferably less ±10%, more preferably less ±5%, which further improvement is established by optimizing process conditions. Thus, for particles varying in size, such as for instance from 300 nm-1500 nm, a shell thickness of for instance 30 nm ±5 nm for all particles is obtained. These facts have been established by TEM and EDS measurements.

In a preferred embodiment the particle according to the invention has a core, which comprises 0.1-99.9999% of the volume and a shell which comprises 99.9-0.0001% of the volume.

The particle may comprise a core with a first electrically conducting material and a shell with a second dielectric material, or a core with a first electrically semiconducting material and a shell with a second dielectric material, or a core with a first electrically conducting material and a shell with a second semiconducting material, or a core with a first electrically semiconducting material and a shell with a second semiconducting material, which second material is different from said first material. Depending on the application one or more of these embodiments will be preferred. For instance, in the case of a photocatalytic or chemically active particle, the core may be electrically conducting, comprising a material such as TiN, and the shell may be a semiconducting material, such as TiO₂₋ₓ, which same particle may also be used for counterfeiting, whereas in the case of “counterfeiting” particles the core may be electrically conducting, comprising a material such as TiN or TaN or a metal, and the shell may be of a dielectric material, such as TiO₂, or the core may be semiconducting, such as Si, and the shell may be dielectric, such as SiO₂, or the core may be semiconducting, such as GaAs or GaN, and the shell may be semiconducting, such as InP or InAs.

With the difference in composition between the first and second material a clear difference is meant. Thus, a particle comprising a first (core) material, of which the composition of the outer part of the core has been slightly changed, due to for instance irradiation with high energy particles, thereby forming a possibly distinguishable shell, e.g. due to a different phase, or due to dislocations or vacancies formed, does not fall under the scope of the present invention. Typically the chemical composition of the present core and the shell differ, thereby imposing different physical and/or chemical characteristics to the core and shell, respectively, such as different electrical characteristics, different chemical activity, or different stability.

For certain aspects of the present invention, such as the photoactivity, the thickness of the shell is bound by strict limits, e.g. due to a desired presence of a core, which has more or less black appearance (see below). If the thickness of the shell is too small or too thick, the effect is lost. Typically in these cases the shell may have a thickness of 5 nm-200 nm, such as 10 nm, or 20 nm, or 100 nm.

In the case wherein the core comprises mainly a first Ti compound, and wherein the shell comprises mainly a second Ti compound, for various applications, such as for photoactivity, and chemical activity, the shell may have a thickness of more than 5 nm, and the core size may be larger than 10 nm. Typically, smaller particles may perform better in applications wherein chemical activity is required.

To obtain optimal effects the particles should not be too large, as the ratio between effective area and volume will decrease. Particles should also not be too small. Clearly the actual size of the particles may be adapted to the use envisaged and this is one of the advantages of the present invention. Thus, the size of the particles, as well as the ratio between the thickness of core and shell, may be optimized for each use or purpose.

Further advantages of the present particles are the ease of use, the low costs involved, their characteristics that can be tailored in a relatively broad scope, envisaged for various uses, there high effectiveness, their high activities in various fields, their relative non-toxicity and environmental friendliness, and their stability in time and in various environments.

As an example of characteristics that may be tailored, the specific absorbance at a certain wavelength, and thus also their activity, can be changed by altering the relative amount of shell (see below).

Such a tailoring of wavelength specifically makes combinations with state of the art techniques possible. If e.g. silicon and the present particles are combined, the efficiency of solar cells is increased, due to the absorbance and generation of electrons in a larger range of wavelengths.

A further advantage is that the present particles show a strong activity in daylight. Thus many applications become available in situations and places where daylight, without a need for some other source of radiation, such as UV-light, is available. This makes the costs of operation extremely low, as no or limited further energy is needed for such operations.

Typical embodiments, uses thereof, and advantages obtained thereby will become clear form the following description and examples.

In a preferred embodiment the first material comprises an element selected from the group of Ti, Al, Hf, Zr, Sr, Si, Ta, a transition metal (group 3 (III B) to 12 (II B) except Ac series), such as Fe and Zn, Si, Ge, C, Ga, As, In, Cd, Ba, or combinations thereof, preferably it comprises Ti.

In a preferred embodiment the second material comprises an element selected from the group of Ti, Zn, Al, Hf, Ga, Cu, Sr, Zr, Si, In, Ga, Ba, or combinations thereof, preferably Ti or SrTi, or BaTi, most preferably Ti.

In a preferred embodiment the first material further comprises an element compensating the valence of a first element selected from the group of C, N, O, P, As, Sb, Se, Te, S, or combinations thereof, preferably N.

In a preferred embodiment the second material further comprises an element compensating the valence of a first element selected from the group of C, N, P, As, Sb, O, S, Se, Te, F, Cl and organic group, or combinations thereof, preferably O.

Again, depending on the desired characteristics and uses envisaged, various combinations may be made. These combinations can be optimized for the envisaged use, thereby making the present invention broadly applicable.

Typical first materials are TiN, a transition metal (group 3 (III B) to 12 (II B) except Ac series), Al, TaN, and semiconductors (IV: Si, Ge, C, SiC, SiGe; III-V: GaAs, GaN, GaP, GaSb, InP, InAs, InSb, InN, II-VI: ZnSe, ZnO, ZnS, ZnTe, CdS, CdSe, CdTe), and a titanate with O₂ vacancies, such as TiO₂, SrTiO₃, BaTiO₃, PbTiO₃, whereas typical second materials are TiO₂, any dielectric such as metal oxide, nitride, fluoride, chloride and organic dielectric materials, and it can also be any of the semiconductive materials as mentioned above.

In a preferred embodiment the particle according to the invention has a shell, which comprises TiO₂, and a core, which comprises TiN.

Thus, preferred particles exhibiting good photoactivity, and/or chemical activity, and/or cleaning activity, and/or anti-microbiological activity, are (core/shell) TiN/TiO₂₋ₓ, or a conductive or semiconductive material such as TiN, Ti, Al, Hf, Zr, Fe, Si, Ge, C, Au, Pt, Ag, Sr, Zn, Ta, Ni, Cu, SiGe, GaAs, GaN, GaP, GaSb, InP, InAs, InSb, InN, ZnSe, ZnO, ZnS, CdS, CdSe, with a TiO₂ shell, respectively, a conductive material with its semiconductive oxide, such as Zn/ZnO, Fe/FeOx, or a conductive or semiconductive material such as Si, Ge, C, SiC, SiGe, GaAs, GaN, GaP, GaSb, InP, InAs/InSb, InN, ZnSe, ZnS, CdS, CdSe, TiN, with a ZnO shell, respectively, or a conductive or semiconductive material such as Si, Ge, C, SiC, SiGe, GaAs, GaN, GaP, GaSb, InP, InAs/InSb, InN, ZnSe, ZnS, CdS, CdSe, TiN, with a SrTiO₃ shell, respectively, or a conductive or semiconductive material such as TiN, Ti, Al, Hf, Zr, Fe, Si, Ge, C, SiC, Au, Pt, Ag, Sr, Zn, Ta, Ni, Cu, SiC, SiGe, GaAs, GaN, GaP, GaSb, InP, InAs, InSb, InN, ZnSe, ZnO, ZnS, CdS, CdSe, with a FeOₓ shell, respectively, or a semiconductive material with TiO₂, or with ZnO, SrTiO₃, FeOₓ, respectively.

Thus, preferred particles exhibiting good Cpuf characteristics are (core/shell) TiN/TiO₂, or a metal with its dielectric or semiconductive oxide, such as Cu/CuO or one of the above, or a dielectric with its metal. The core part could be any conductive and semiconductive material, such as transition metal (group 3 (III B) to 12 (II B) except Ac series), Al, TiN, TaN and semiconductors (IV: Si, Ge, C, SiC, SiGe; III-V: GaAs, GaN, GaP, GaSb, InP, InAs, InSb, InN, II-VI: ZnSe, ZnO, ZnS, CdS, CdS) and titanate with O₂ vacancy (TiO₂, SrTiO₃, BaTiO₃, PbTiO₃). Examples hereof are given above.

The shell part could be any dielectric, such as metal oxide, nitride, fluoride, chloride and organic dielectric materials. It also can be semiconductive materials (as mentioned above) with conductive core.

The preparation of core-shell particles could be by oxidizing, nitridation, fluoridizing and chlorizing of a particle surface or coating a layer on a particle using a sol-gel method, hydrothermal method, spray-drying, spray-pyrolysis, freeze-drying, plasma-spraying method, and so on.

In the case of oxidation of the surface of a metal, a typical core-shell particle is an Al core with an Al₂O₃ shell, a doped-Si core with a SiO₂ shell, a Cu core with a CuO shell, a Ta core with a Ta₂O₅ shell and a TiN core with a TiO₂ shell. In the case of a coating, a metal core with an oxide coating would be preferable.

Preferable the particle size exhibiting good Cpuf characteristics depends on the design of the electrode used in the application and distance between electrodes in the packaging. For instance, if the distance between 2 electrodes is 2 μm, then the particle size should be more than 1 μm and less than 2 μm. Thereby there are sometimes particles between adjacent 2 electrodes, and sometimes no particle is present between those electrodes, but is may present above the electrodes. Therefore, the particle size is typically larger than 0.2 μm, preferably larger than 0.2 μm, but smaller than 3 μm.

In a second aspect the invention discloses a method of manufacturing a particle according to the invention, comprising the steps of:

i) providing particles comprising a first electrically conducting or semiconducting material, forming a core,

ii) forming a shell around the core comprising a second dielectric or semiconducting material, wherein the shell has a thickness of more than 10 nm, preferably more than 30 nm, more preferably more than 50 nm.

The preparation of core-shell particles could be by oxidizing, nitridation, fluoridizing, sulphidizing, selenizing, and chlorizing of a particle surface or coating a layer on a particle using a sol-gel method, hydrothermal method, spray-drying, spray-pyrolysis, freeze-drying, plasma-spray method and so on.

In the case of oxidation of the surface of a metal, typical core-shell particle could be an Al core with an Al₂O₃ shell, a doped-Si core with a SiO₂ shell, a Cu core with CuO, a Ta core with Ta₂O₅, and TiN with TiO₂. In the case of coating, a metal core with oxide coating would be preferable.

In a preferred embodiment the first electrically conducting material comprises TiN, wherein the second dielectric material comprises TiO₂, wherein in step ii) the first electrically conducting material is heated for more than 15 min. to a temperature of more than 400° C., in an atmosphere comprising O₂.

In a third aspect the invention discloses a use of a particle according to the invention, such as TiN/TiO₂, as a photocatalyst, wherein the shell is semiconducting, and wherein the photocatalyst is activated by radiation within a wavelength from about 300 to about 850 nm. Thus, besides UV-radiation in the wavelength region of about 300- about 400 nm, the present photocatalyst may be activated by radiation with a wavelength from about 600-850 nm, or by radiation with a wavelength from about 400-600 nm, or by a radiation source with specific wavelengths, or combination thereof, such as xenon-light or sunlight.

By tailoring the relative amounts of core and shell and compositions thereof, the wavelength regions wherein the particles show an improved absorbance of light and/or activity can be further adapted, e.g. by varying the thickness of the shell, the composition of the core and/or shell, etc. As a consequence the particle may absorb light at e.g. a larger wavelength, in the IR region, or at wavelengths from e.g. 400-600 nm, or at smaller wavelength, in the UV-region, or combinations thereof. An example of a photocatalyst according to the invention, comprising 16% TiO₂, exhibits an absorbance of more than a few percent in the region from 300 nm to almost 900 nm, and an absorbance of more than 20% in the region from 450 nm to almost 800 nm, and an absorbance of more than 80% in a region from about 480 nm to about 680 nm. Such a particle comprises for instance TiN with TiO₂.

In a further aspect the invention discloses a photocatalyst comprising a particle according to the invention, wherein the shell is semiconducting. Such a particle comprises for instance TiN with TiO₂.

In a further aspect the invention discloses a device comprising a photocatalyst according to the invention. Such a device can be a chemical reactor or a solar cell.

In a further embodiment the invention discloses a use of a particle according to the invention, as a chemical agent, which agent is capable of decomposing water. Water is then decomposed into H₂ and O₂. This decomposing feature can be used to produce H₂, which clearly is, for instance, a clean source of energy.

In a further embodiment the invention discloses a use of a particle according to the invention, as a chemical agent, which agent is capable of decomposing organic material, such as acetaldehyde, soil, organic solvents, surfactants, agrochemicals, environmental pollutants, and odors into e.g. smaller compounds such as H₂O, CO₂, and/or which is capable of reducing compounds, such as benzoic acid, carbon dioxide and NOx. Such a particle comprises for instance TiN with TiO₂.

In a further embodiment the invention discloses a use of a particle according to the invention, as a chemical agent, which agent is capable of acting as an anti-fogging material. Such a particle comprises for instance TiN with TiO₂.

In a further embodiment the invention discloses a use of a particle according to the invention, wherein the shell is dielectric, in security coatings. Typically, a coating, comprising particles according to the invention, protects the information stored on an underlying chip from being copied, read and misused, or the coating itself creates secret codes. As such, a conductive material is embedded in a dielectric material. Such a particle comprises for instance TiN with TiO₂.

As mentioned above, surprisingly the particles according to the invention can be made in a reproducible way, offering the required characteristics for the intended purposes.

Advantages of the present particles are:

an increase of lateral variety of effective dielectric constant over circuits,

they can give a different effective dielectric constant depending on composition of core-shell and thickness of core and shell, respectively, and

many materials can be applied for the objected purpose.

In a further embodiment the invention discloses a use of a particle according to the invention, in a solar cell.

In a further aspect the invention discloses a solar cell comprising a particle according to the invention, wherein the shell is semiconducting. Such a particle comprises for instance TiN with TiO₂.

In a further aspect the invention discloses a device comprising a solar cell according to the invention.

Solar cells are one of the most promising clean sources of energy that could partially replace fossil fuel. However Si solar cells are still expensive (financial amortization) and not efficient compared with the other sources of energy. Furthermore, the production of solar cells consumes a lot of energy and it takes years until this amount is obtained back from the solar cell (environmental amortization). There is currently much research done on reducing costs and improving efficiency of the solar cell. For instance thin film Si technology and a dye-sensitizing solar cell could be an option to reduce cost. However, these are not very efficient. Multiple-junction solar cells using compound semiconductors could give more than 40% efficiency, but they are very expensive because of the compound semiconductor materials and the integration cost. In order to exchange from conventional to alternative energy sources like solar cell a cheaper and more efficient solution is required. In literature different ways to enhance the efficiency can be found like up and down-converters, semiconductors with different energy gaps, hot carrier cells. But these solar cells are expensive and consume a lot of energy during manufacturing.

In this application we describe a very cost-effective and very efficient way of producing energy from sunlight. Without wishing to be bound by theory, the inventors believe that the energy can be transformed into electrical energy or into hydrogen and oxygen (chemical energy). It is believed that one of the main characteristics of this application is the effect the thickness of the shell of the particles has on the appearance thereof. If the shell thereof becomes too thick, the color of the particles changes from black to for instance yellow. As a consequence, the absorption of light is limited, for instance because not all or most of the wavelength present therein can be absorbed. Thus, such particles become less efficient in terms of energy conversion. If the shell thickness becomes to small, gaps within the shell start to appear, and as a consequence no (visible) light will be absorbed in such gaps. By varying the thickness of the shell the specific absorption range, in terms of wavelength/energy, can be tailored. So, nanoparticles with different diameters and different shell thickness can be used to broaden the absorption spectra and thus enhance the energy conversion efficiency.

The inventors believe, without wishing to be bound by theory, that the thickness of the shell is bound by strict limits, e.g. due to a desired presence of surface plasmons and/or quantum confinement. If the thickness of the shell is too small or too thick, the effect is lost. Typically in these cases the shell may have a thickness of 5 nm-200 nm, such as 10 nm, or 20 nm, or 100 nm. Furthermore, the momentum conservation must be fulfilled. So nanoparticles with different diameters can be used to broaden the absorption spectra and thus enhance the energy conversion efficiency.

To further enhance the absorption rate and the absorption spectra a dye can be applied on the surface of the nanoparticles. Such dye molecules are known in literature such as organic Ru complexes.

Advantages of said solar cell are:

a cheaper and simpler method than standard PN junction type solar cells,

a more efficient than colloidal photocatalyst and Si solar cell,

the possibility to integrate several layered semiconductive materials to widen absorption spectra,

less energy needed to produce this device than a Si solar cell (environmentally friendlier).

In a further aspect the invention discloses a coating or thin film comprising a particle according to the invention. For instance, a particle has been provided in a coating on a surface of a base material substrate. Said base material is for instance an exterior wall of a building, an exterior plane of a roof or a ceiling, an outer plane or an inner plane of a window glass, an interior wall of a room, a floor or a ceiling, a blind, a curtain, a protective wall of highway roads, an inner wall inside a tunnel, an outer plane or a reflective plane of an illuminating light, an interior surface of a vehicle, or a plane of a mirror. Said coating than provides the same or similar advantages as the present particle. Such coatings can be applied by standard techniques. Such a particle comprises for instance TiN with TiO₂.

In a further aspect the invention discloses a device comprising a coating according to the invention. Clearly said coating can form part of a device.

In a further aspect the invention discloses a chemical agent comprising a particle according to the invention. The agent can be in the form of a solution, in the form of granulates, or in the form of a liquid. Such a particle comprises for instance TiN with TiO₂.

In a further aspect the invention discloses a device comprising a chemical agent according to the invention. Such a device can be a wastewater apparatus, an air cleaning apparatus, a sanitation device, which decomposes part or all of pollutants present therein.

In a further aspect the invention discloses a use of a particle according to the invention in a system producing hydrogen. As for instance TiO₂ is capable of producing H₂ from water, various embodiments of the present particle can be used for said purpose.

In a further aspect the invention discloses a use of a particle according to the invention for killing microbes. Such a device can be a wastewater apparatus, an air cleaning apparatus, a sanitation device, which decomposes part or all of the bacteria and/or fungi present therein.

So clearly advantages of the present invention are:

a very efficient antibacterial effect, as close to 100% of bacteria have been killed within 5 mins. with very low concentration of this powder (50 mg/l).

In a further aspect the invention discloses a use of a particle according to the invention as a cleaning agent. The working principle of the particle as cleaning agent is closely related to the killing of microbes and the decomposing agent. Such a particle comprises for instance TiN with TiO₂.

The present particles also exhibit combined effects. Thus, particle may be used to purify water and/or air, wherein both pollutants are effectively removed and bacteria are killed. Advantages are:

a cheap and simple method to purify air and water under wide range of visible light (inside and outside of house),

it is more efficient than filtering and/or standard TiO2 photocatalytic decomposition of pollutants,

and it is easy to create different sizes and structures.

Particles according to the invention may be present in concentrations of 5-40 mg/L, such as 10-30 mg/L, or 10⁻⁵−5*10⁻¹ gr/cm² of area to be covered, such as 10⁻⁴−10⁻¹ gr/cm², preferably 10⁻³−5*10⁻² gr/cm². Typically, the particle should cover the area where there is a light source, thus the number of the particle also depends on particle size. In order to make a film from the powder, such a film may contain a binder to connect particles to each other, but preferably no material should be left between the powder after preparation of the film, in order to optimize the efficiency of the film. In order to improve efficiency of the present powder as a photocatalyst, Pt can be used as additive. Further components that may be present, depending on the application envisaged, are fillers, solvents, stabilizers, homogenizers, emulsifiers.

In a further aspect the invention discloses a particle obtained by the method according to the invention.

The following examples are intended to illustrate the various aspects of the present invention. The examples are not meant to limit the invention in any way.

Further, is may be clear to the person skilled in the art that various combinations of the embodiments are also envisaged and also fall within the scope of the present invention.

### BRIEF DESCRIPTION OF THE DRAWINGS

FIG. 1 shows crystal structures for oxidized TiN powder.

FIG. 2 shows the amount of TiO₂ vs. O₂ in mixture of O₂ and N₂ gasses.

FIG. 3 shows an amount of TiO₂ vs. amount of raw TiN powder.

FIG. 4 shows an XRD diffraction pattern for TiN powder.

FIG. 5 shows TEM and EDS results of the oxidized TiN powder

FIG. 6 shows crystal structures for oxidized TiN powder.

FIG. 7 shows an optical absorption spectrum of TiN core-TiO₂ shell powders.

FIG. 8 shows a decomposition of AO after exposure of halogen lamp.

FIG. 9 shows amount of bacteria died after exposure of halogen lamp in bio films.

FIG. 10 shows TiN core-TiO2 shell photocatalyst.

FIG. 11 shows a meander comb structured TiO2-type photocatalyst with (X-section).

FIG. 12 shows a meander comb structured TiO2-type photocatalyst with (top-down, structure 1).

FIG. 13 shows an schematic diagram of water/air purification.

FIG. 14 shows greatzel cell

FIG. 15 shows core shell particle in coating.

### DETAILED DESCRIPTION OF THE EMBODIMENTS

### Examples

### Example 1 Oxidation of TiN

TiN powder was heat-treated at 400-600° C. for 1 hr in O₂. Both 1.45 g and 0.25 g of TiN powder began to be oxidized at 500° C. At 600° C. TiN powder was oxidized completely and the anatase phase present was converted to the rutile phase. 500° C. is regarded as the optimum temperature in the range mentioned to obtain the maximum amount of anatase.

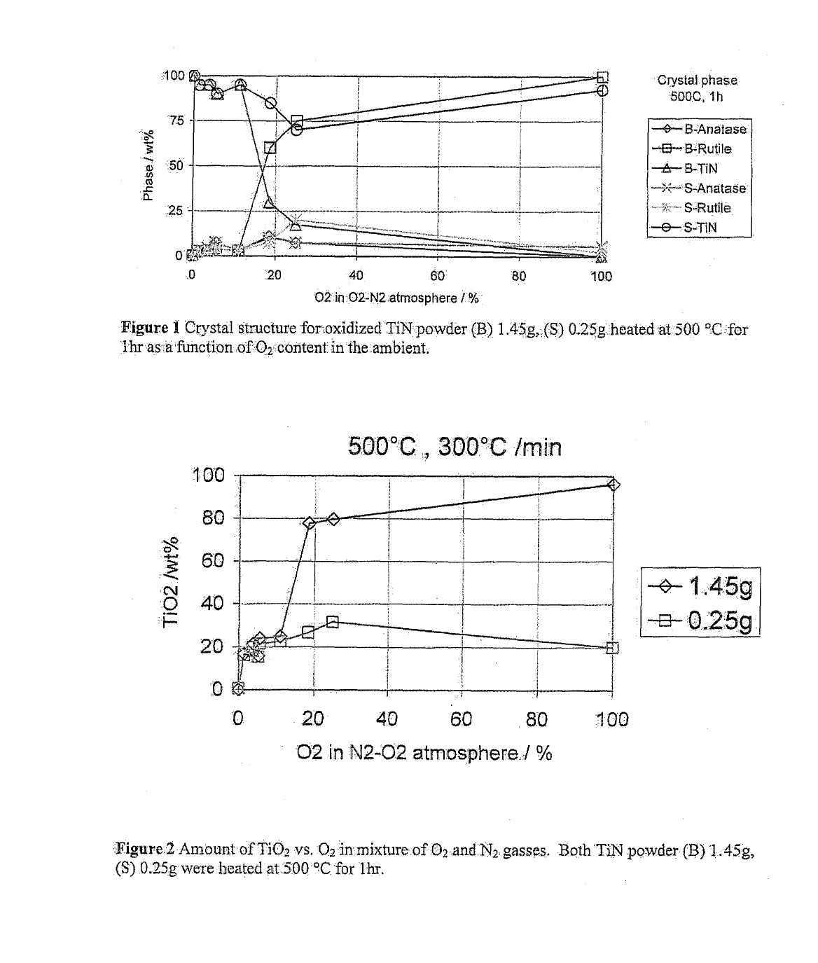

FIG. 1 shows the effect of O₂ (%) in a mixed gas on the crystal structure of the oxidized TiN powder. Anatase was mainly formed at 4-19% of O₂ for 0.25 g TiN powder and 2-6% O₂ for 1.45 g TiN powder. According to FIGS. 1 and 2, the samples with about 20 wt % (e.g. 15-25 wt %) of TiO₂ have anatase as a main phase on the surface of TiN powder.

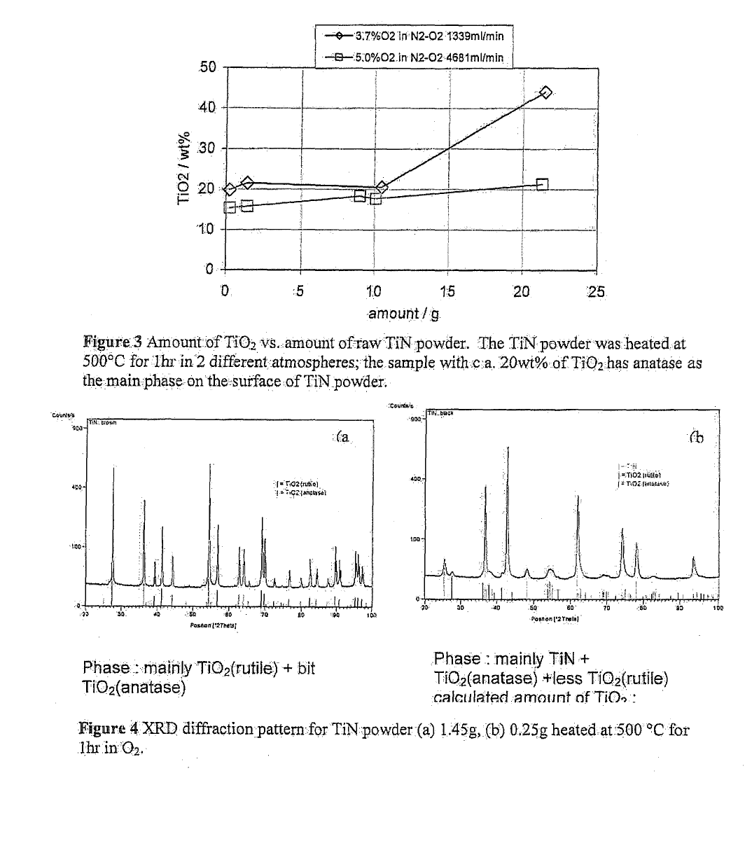

FIG. 3 shows the effect of the amount of TiN powder on the amount of the TiO₂ formed. The TiN powder was heated at 500° C. for 1 hr in 2 different atmospheres. 5% O₂ in a mixed gas gave approximately 20 wt % oxide for 0.25, 1.45, 10 and 21 g TiN as a raw powder. The heat treatment at 500° C. for 1 hr in this ambient can provide a large amount of anatase on TiN core.

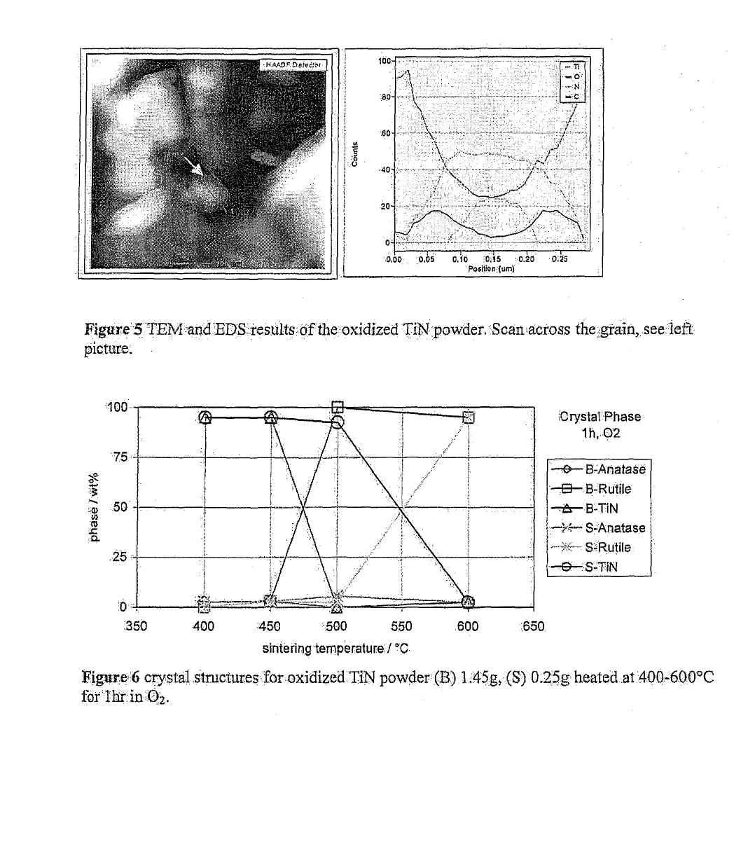

According to the XRD pattern (FIG. 4) the oxidation depends on the amount of the TiN powder, i.e. how the TiN powder was mounted in a container, such as the height of the packed powder and the packing density of the powder. This is due to the fact that the oxidation is an exothermic reaction. If 1.45 g of the TiN powder was oxidized, the powder was completely oxidized and rutile is the main phase. While if 0.25 g of the TiN powder is oxidized, a TiN core and a TiO₂ shell was formed, wherein anatase is the main phase (FIG. 5).

This oxidation also depends on temperature and atmosphere during the heat treatment, thus several experiments have been carried out to find preferable conditions, under which anatase is mainly formed. FIG. 6 shows the crystal structure for the oxidized TiN powder.

### Example 2 Absorption of light of TiN core-TiO₂ shell powders

FIG. 7 shows optical absorption spectra of TiN core-TiO₂ shell powders. The powder composed of 4% TiN and 96% TiO2 absorbs the light at less than 550 nm, which is higher than UV light (wavelength (λ)<387 nm). Further, the powder composed with 84% TiN and 16% TiO2 absorbs the light at less than 850 nm. Both powders, especially the high TiN content powder, adsorb a wide range of visible light (λ>387 nm).

### Example 3 Photo catalytic activity of TiN core-TiO₂ shell powders.

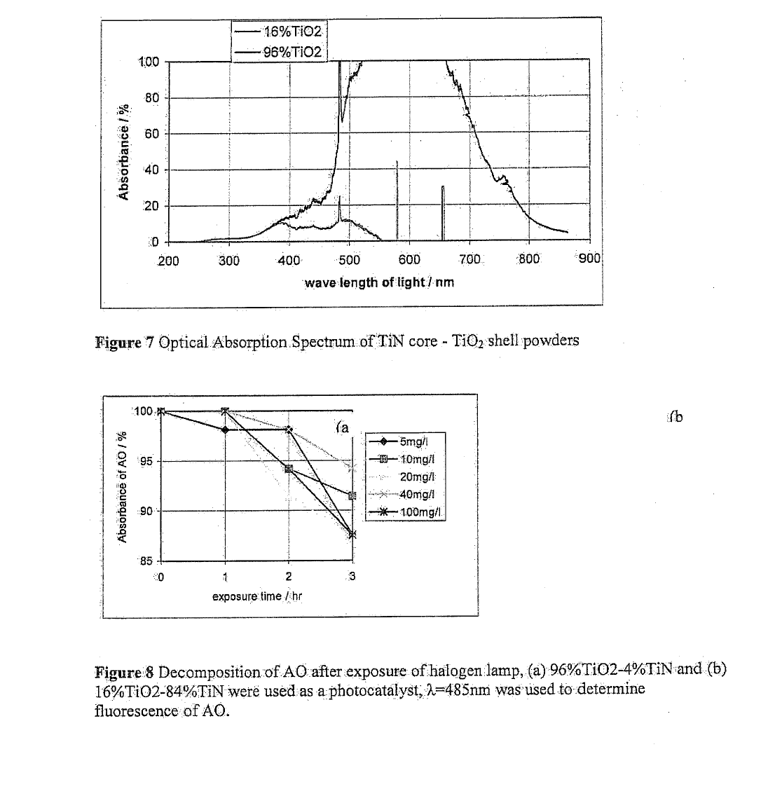

The photocatalytic activity of the powders was evaluated by photodegradation of acid orange 7 (AO7), which is an organic compound, commonly used as an azodye, under a halogen lamp (400<λ<850). 2 ml of an AO7-water solution (20 mg/l) was mixed with a TiN core-TiO₂ shell powder-water solution with a concentration of 5-100 mg/l. It is noted that it is in general difficult to decompose azodyes, because they are intentionally designed for resistance to degradation. However, FIG. 8 shows that both powders decompose AO7 after 1 h of exposure to the halogen lamp, which is exceptionally fast. This phenomenon shows the strong photocatalytic activity of the present particles.

The photocatalytic reaction strongly depends on the distance to a light source and on the surfacearea of powders used. The solutions with a low concentration of the powders show a relatively high photodegradation rate. This can be due to a decrease of surface area of the powders by agglomeration, or due to the light scattering by the particles.

### Example 4 Antibacterial activity of TiN core-TiO₂ shell powders.

Streptococcus mutans ATCC 700610 has been used as bacteria, which was incubated in a brain heart infusion (BHI) broth for 8 h at 37° C., which was used as test organism. Of this culture, 0.5 ml was mixed with 25 ml of BHI+2% sucrose, and aliquots of 0.2 ml suspension were added into sterile wells of a 96 well plate. The plate was incubated at 37° C. for 16 h. Sticky layers of bacteria (biofilms) were formed at the bottom of the wells. Subsequently the BHI medium was removed from the bio films and the TiN/TiO₂ powder suspension (50 mg/l) was added. The wells were exposed to a halogen lamp for different time periods. The death ratio of bacteria was determined by fluorescence microscopy, using a Live/dead fluorescent viability stain. FIG. 9 shows that 5 mins. of exposure under the halogen lamp killed almost 100% of the bacteria with the powder composed of 4% TiN and 96% TiO₂, while with the 84% TiN and 16% TiO₂ powder this took 15 minutes. With pure TiO₂ these high killing ratios were not reached at all.

### Example 5 Hydrogen production using a nanostructured device comprising a photocatalyst.

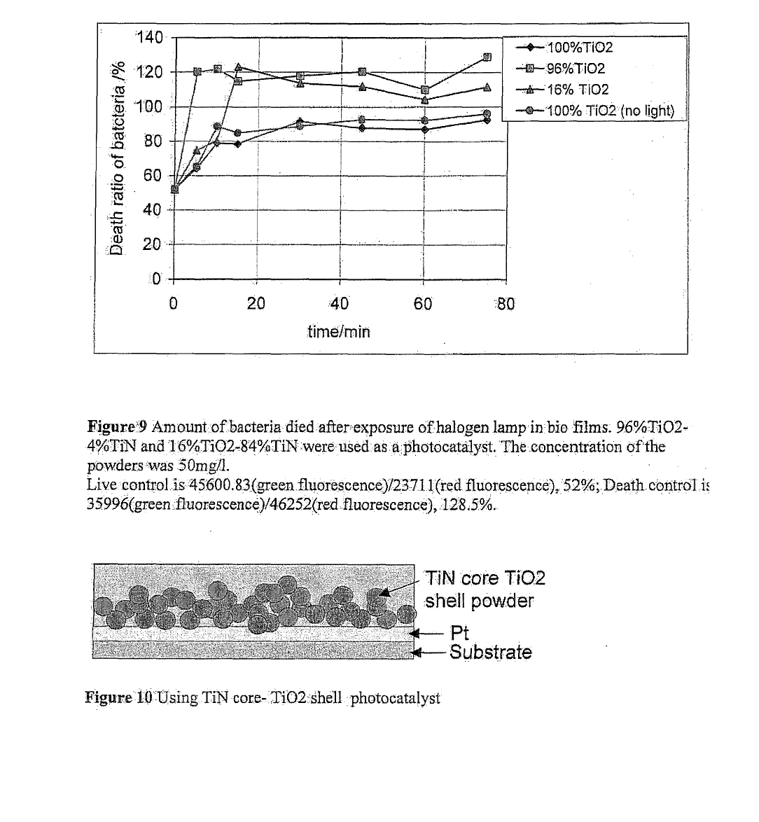

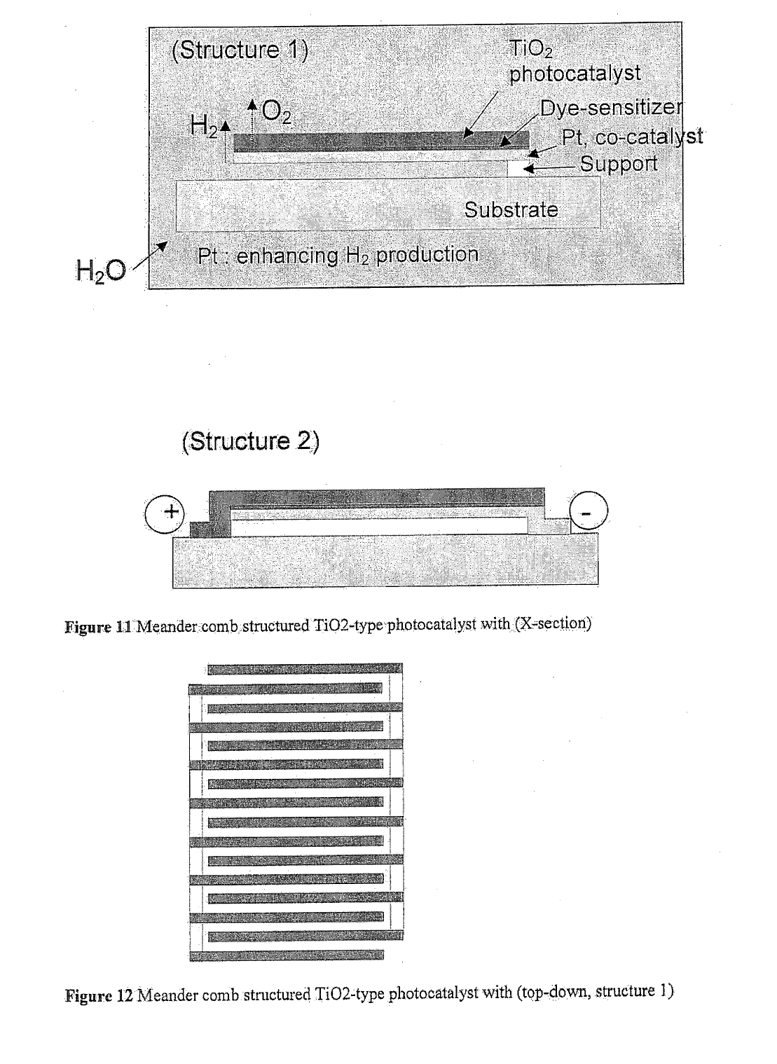

A simple way is to make a porous structure using a TiN core-TiO₂ shell powder according to the invention on a Pt deposited substrate (FIG. 10). However, it is noted that this method may have a difficulty to have enough water to reaching the Pt surface. In order to solve this problem, one possibility is a nanostructured beam comprising a TiN core-TiO₂ shell powder with cavity. FIG. 11 shows two different types of meander-comb structures. The structure 1 is composed with a beam of layered catalyst supported by an insulation layer on a substrate. The layered catalyst is made of TiO₂ as a top photoactive layer, either directly on Pt, or with a dye-sensitizer between TiO₂ and Pt. Here Pt functions as a co-catalyst reduction agent to enhance hydrogen formation from water. TiO₂ acts as a photocatalyst under UV light region only, whereas a dye-sensitizer extends light absorption towards the visible light region. Instead of Pt other metals can be used as a reduction agent. Both inorganic and organic material can be used as the insulation layer, such as silicon dioxide (SiO₂), silicon nitride (Si₃N₄) and epoxy resin. A TiN core-TiO₂ shell powder is used as a photocatalyst, instead of TiO₂ without a dye-sensitizer. The structure 2 is a photoelectrochemical cell, wherein a top TiO₂ layer is the anode, and a Pt layer is the cathode. The dye-sensitizer is integrated between a TiO₂ layer and a Pt layer, to extend light absorption. Here, also a TiN core-TiO₂ shell powder is used as a photocatalyst, instead of TiO₂. In this case the dye-sensitizer is not necessary.

In both structures water also flows through the cavity, between the beam and the substrate, which makes water splitting very efficiently form hydrogen on the Pt side.

FIG. 12 shows top-down view of the structures 1.

The processing of these structures is simple if the cavity part will be made of an organic material, which is evaporated at a low temperature treatment (200° C.), for instance typical airgap materials, or material that can be easily dissolved with a wet cleaning solution, such as acid and base solutions.

Another possibility is to use materials like PMMA, which decompose at higher temperatures. Or SiO₂ is used as a sacrificial layer, which is dissolved in HF solution and the support is nitride or another material, which is inert for HF.

### Example 6 Water/air purification using a TiN core-TiO₂ shell photocatalyst according to the invention with a filter.

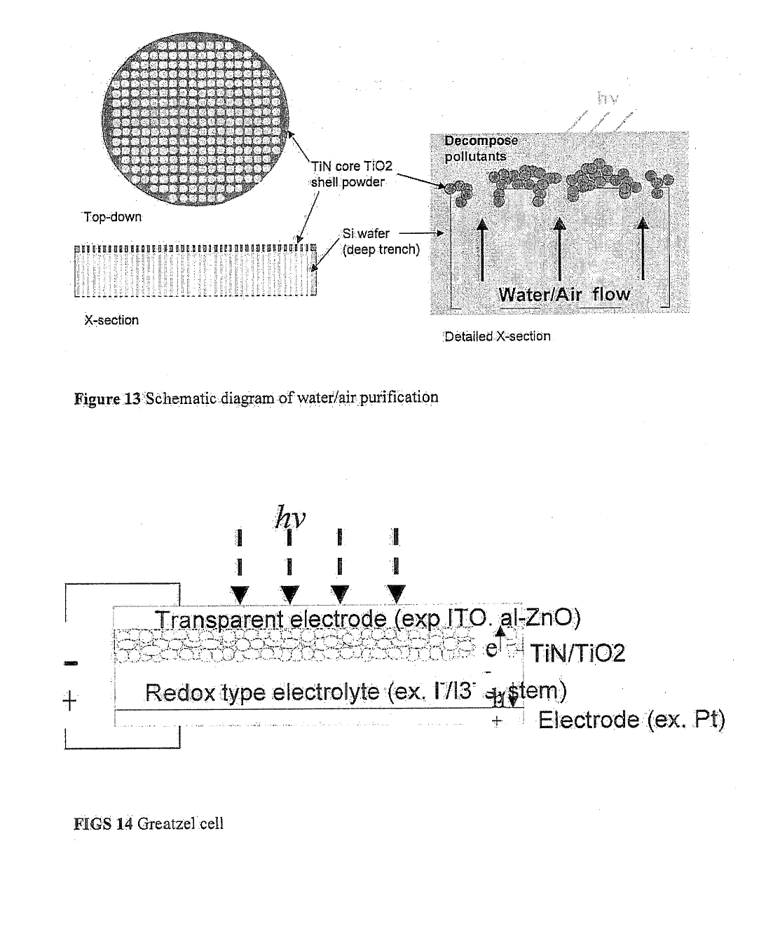

In order to purify water and/or air the core-shell photocatalyst according to the invention is deposited on a sub-micron deep trench Si structure. FIG. 13 shows a top-down and X-sectional view of the proposed structure.

First, the deep trench was patterned into a Si wafer by the Bosch method. After that the core-shell powder according to the invention has been deposited, by a spin-coating method on top of the Si wafer, and heat-treated to attach on the Si surface under an inert atmosphere. As shown in the figure, air or water flows from the bottom of the Si wafer. Particles or a material, which have a bigger size than the diameter of the trench hole, are removed by the nanostructured Si, and the remainder of materials, such as pollutants, parasites and bacteria, are decomposed and killed by TiN core-TiO₂ shell photocatalyst, under visible light, which is present for instance inside or outside a house.

### Example 7 Solar cell

It is noted that in a future solar cell many nanoparticles, with an average distance from each other between 100 nanometer and several micrometer, will be used. Also nanoparticles with different diameters, or with a non-spherical shape, are used. In the latter case also larger particles, with sharp corners or with surface roughness, are used. A general description of the manufacturing process of TiN/TiO₂ powders can be found above.

Graetzel cell

The advantage of using a Graetzel cell geometry (see FIG. 14) is that no expensive high quality semiconductor is used. This results in a very simple and cost-effective device for producing electrical energy. Due to the high absorption rate already one layer of nanoparticles on the transparent electrode is enough resulting, in an extremely thin and simple geometry. The redox mediator is needed for positive charge transfer, from the nanoparticle to the counterelectrode. A very thin film of Platinum, to catalyze the reduction of the redox mediator, can cover this electrode. Since here the catalyzing is a surface effect, already a very thin film is enough to ensure a low-cost production.

Advantages of the above solar cells are:

a very cost-effective and very efficient solar cell is provided by using TiN/TiO₂ powders. There is no need for expensive (financially and environmentally) crystalline Si or amorphous hydrogenated Si, with a limited lifetime.

they are easy to manufacture, even in large volumes and large dimensions.

a small amount of energy is needed for production of solar cells, giving a fast environmental amortization.

Furthermore, the semiconducting material, surrounding the metallic nanoparticle, gives rise to a high enhancement factor. In earlier geometries the nanoparticles are deposited on top of the solar cell, using also the light scattering of the nanoparticles.

### Example 8 Core-shell particle in coating Puf

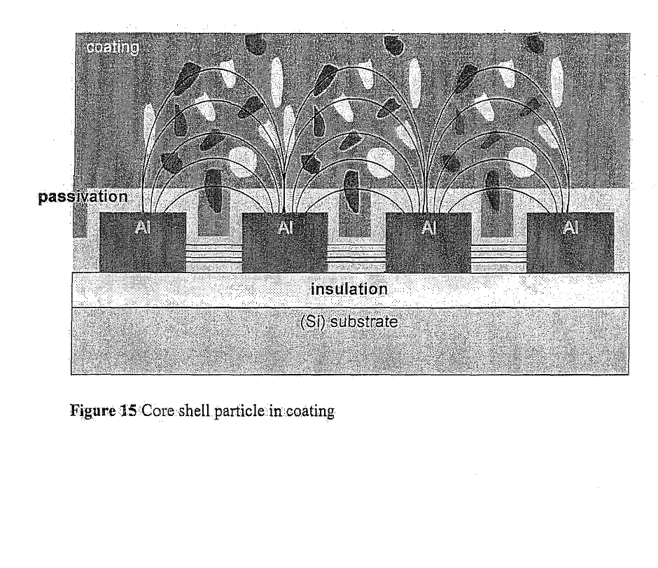

We have been developing a so-called “coating physical unclonable functions (Cpuf)”, which is a coating composite on an IC. FIG. 15 shows a schematic diagram for this coating.

A standard Cpuf is composed with two different particles; conductive (blue) and dielectric (yellow) in matrix material (left of FIG. 15). If we have particles comprising a conductive core with a dielectric shell, instead of conductive particles (middle and right of FIG. 15), the capacitance of the particles will be varied significantly with the thickness of the shell, the size of the core, and material compositions of both core and shell. It increases the randomness of capacitance over circuits. The particle behaves as a dielectric material, and it is for instance modeled as a series of 2 parallel capacitors in AC bias. The thickness of the shell is smaller than the particle size, therefore the particle has a relatively high k-value and the total capacitance of the coating is increased. If the shell of the particle behaves either semiconductive or dielectric, depending on thickness, morphology, crystal structure and vacancies, it will further increase the randomness of capacitance. For instance, several titanates are used as a shell for above purpose.

1. A nano-particle comprising:
a core of a size having a first electrically conducting or semiconducting material,
a shell of a thickness having a second dielectric or semiconducting material,
wherein the composition of said second material is different from the composition of said first material, and
wherein the shell thickness is less than or equal to the core size.

2. A nano-particle as recited in claim 1, wherein the first material comprises an element selected from the group of Ti, Al, Hf, Zr, Sr, Si, Ta, a transition metal (group 3 (III B) to 12 (II B) except Ac series), Si, Ge, C, Ga, As, In, Zn, Cd, or combinations thereof.

3. A non-particle as recited in claim 1, wherein the second material comprises an element selected from the group of Ti, Zn, Al, Hf, Ga, Cu, Sr, Zr, Si, In, Ga, Zn, Ba, or combinations thereof.

4. A nano-particle as recited in claim 1, wherein the first material further comprises an element compensating the valence of a first element selected from the group of C, N, O, P, As, Sb, Se, Te, S, or combinations thereof.

5. A nano-particle as recited in claim 1, wherein the second material further comprises an element compensating the valence of a first element selected from the group of C, N, P, As, Sb, O, S, Se, Te, F, Cl and an organic group, or combinations thereof.

6. The nano-particle as recited in claim 1, as a photocatalyst, wherein the shell is semiconducting.

7. The nano-particle as recited in claim 1, wherein the nano-particle functions as a chemical agent, which agent is capable of decomposing water.

8. The nano-particle as recited in claim 1, wherein the nano-particle functions as a chemical agent, which agent is capable of decomposing organic material, such as acetaldehyde, soil, organic solvents, surfactants, agrochemicals, environmental pollutants, and odors, and which is capable of reducing compounds, such as benzoic acid, carbon dioxide and NOx.

9. The nano-particle as recited in claim 1, wherein the nano-particle functions as a chemical agent, which agent is capable of acting as an anti-fogging material.

10. The nano-particle as recited in claim 1, wherein the nano-particle functions as a security coating, and wherein the shell is a dielectric.

11. The nano-particle as recited in claim 1, where in the nano-particle functions as a solar cell.

12. Coating or thin film comprising a particle as recited in claim 1.

13. Solar cell comprising a particle as recited in claim 1, wherein the shell is semiconducting.

14. Chemical agent comprising a particle as recited in claim 1.

15. Photocatalyst comprising a particle as recited in claim 1, wherein the shell is semiconducting.

16. Security coating comprising a particle as recited in claim 1, wherein the shell is dielectric.

17. The nano-particle as recited in claim 1, functioning as one of the following: in a system for producing hydrogen, as a material for killing microbes, as a cleaning agent.

18. (canceled)

19. (canceled)

20. Device comprising a coating according to claim 12.

21. Device comprising a solar cell according to claim 13.

22. Device comprising a chemical agent according to claim 14.

23. Device comprising a photocatalyst according to claim 15.

24. The nano-particle as recited in claim 1,
wherein the shell thickness is in the range of about 10 nm to about 200 nm; and
wherein the core size is in the range of about 100 nm to about 100 μm.

25. The nano-particle, as recited in claim 24,
wherein the shell thickness is in the range of about 50 nm to about 200 nm; and
wherein the core size is in the range of about 250 nm to about 100 μm.
